(19) United States
(12) Patent Application Publication
(10) Pub. No.: US 2010/0062784 A1
(43) Pub. Date: Mar. 11, 2010

(54) METHOD AND APPARATUS FOR ALLOCATING A COMMUNICATION CELL TO A CLUSTER

(76) Inventors: Lars ORNBO, Aalborg (DK); Martin J. SCHMIDT, Bronshoj (DK)

Correspondence Address: FITCH EVEN TABIN & FLANNERY, 120 SOUTH LASALLE STREET, SUITE 1600, CHICAGO, IL, 60603-3406, US

(21) Appl. No.: 12/205,690

(22) Filed: Sep. 5, 2008

(51) Int. Cl. H04W 72/00

(52) U.S. Cl. 455/452.1

(57) ABSTRACT

A network element for supporting broadcast communications over a communication system comprises allocation logic operable to dynamically allocate at least one communication cell to a cluster of communication cells based on an identified geographical location of the at least one communication cell.

### FIELD OF THE INVENTION

This application relates generally to cellular communications, and more specifically to allocating cells to a cluster of communication cells to assist the delivery of broadcast services.

### BACKGROUND OF THE INVENTION

The demand for multimedia services that can be received via mobile phones and other handheld devices is set to grow rapidly over the next few years. As a consequence of the services that are desired by end-users, multimedia services require high communication bandwidths. The most cost-effective way of providing such services is in a form of broadcast transmissions, rather than unicast (i.e. point-to-point) transmissions. Typically, tens of channels carrying news, movies, sports, etc. are broadcast simultaneously over a network, to potentially thousands of handheld devices.

Technologies for delivering multimedia broadcast services over cellular systems, such as the Mobile Broadcast and Multicast Service (MBMS), have been developed. MBMS is a broadcasting and multicasting service offered over mobile telecommunications networks, such as General Packet Radio System (GPRS) networks, Universal Mobile Telecommunication System (UMTS) networks, Evolved Packet System (EPS), and the like. The technical specifications for MBMS include 3GPP TS 22.146, 3GPP TS 23.246 and 3GPP TS 26.346.

Some cellular networks are arranged to deliver only broadcast services. In such a system, each individual cell (supported by a Node B) forms a whole cluster, which may be one cell, a sector of a cell, part of a cluster of cells, or a cluster either defining a subset of the cells of the network or, in some instances, the cluster may define all of the cells of the network. Broadcast services are transmitted simultaneously using identical physical resources by all cells of a cluster, thereby allowing mobile stations/user equipment to combine signals received from more than one cell. Broadcast services may be transmitted by more than one cluster, in which case all cells of the plurality of clusters involved will use identical physical resources for the broadcast.

### SUMMARY OF THE INVENTION

One of the challenges when managing a cellular network that delivers broadcast services is the assignment of cells to clusters. A need exists for an improved method and apparatus for allocating cells to clusters and thereafter supporting, for example, multimedia broadcast multicast services to those cell clusters wherein one or more of the abovementioned disadvantages may be alleviated.

Accordingly, the invention seeks to mitigate, alleviate or eliminate one or more of the abovementioned disadvantages, singly or in any combination.

According to a first aspect of the invention, there is provided a network element for supporting broadcast communications over a communication system wherein the network element comprises allocation logic for dynamically allocating at least one communication cell to a cluster of communication cells based on an identified geographical location of the at least one communication cell.

According to an optional feature of the invention, the network element further comprises processing logic operably coupled to the allocation logic wherein the processing logic is operable to receive a message from the at least one communication cell upon power on of the at least one communication cell informing the network element of its geographical location and the allocation logic is operable to allocate the at least one communication cell to a cluster of communication cells based on the informed geographical location. In one embodiment of the invention, a base station arranged to support communications in the at least one communication cell comprises location determination logic operable to determine a geographical location of the base station, and transmit logic operable to inform the network element of its geographical location.

Thus, by informing the network element of the base station's/cell's geographical location, the network element is able to allocate, for example in a dynamic manner, the cell to a particular cluster of communication cells based on its geographical location. In this manner, services such as broadcast services can be targeted and supported through a particular network element, such as a radio network controller (RNC), in a particular geographical region for a cluster of cells supported by the network element.

According to an optional feature of the invention, the network element may further comprise memory logic for storing geographical location information associated with a cluster of communication cells, wherein the allocation logic is operable to allocate the at least one communication cell to a cluster of communication cells based on an identified geographical location of the cell obtained from the memory. This may allow a more efficient use of processing resources, with lower requirements for bandwidth in the transport network. Alternatively, the network element may further comprise extraction logic operable to extract geographical location information associated with a cluster of communication cells from a remote memory, such that the allocation logic is operable to allocate the at least one communication cell to a cluster of communication cells based on an identified geographical location of the cell obtained by the extraction logic. This may allow for the geographical location information to be stored either within the network element or remotely.

According to an optional feature of the invention, the communication system may comprise radio allocation logic operable to allocate the at least one communication cell to a radio network controller responsible for control of communication cells of the cluster.

According to an optional feature of the invention, the network element may further comprise a graphical user interface operable to provide a visual representation of a cluster of cells. In this manner, for example, the identified geographical location of a plurality of cells may be used by additional processing logic that is operable to determine whether an area in the cluster has a relatively high probability of suffering from poor communication coverage.

In one optional embodiment of the invention, the communication system may comprise a Multicast Broadcast over a Single Frequency Network (MBSFN), such that the network element may transmit the same signal using the same physical resources to a number of wireless base stations within a cluster of cells allocated based on their identified geographical locations.

According to a second aspect of the invention, there is provided a method for allocating at least one communication cell to a cluster of communication cells. The method comprises identifying a geographical location of the at least one communication cell; and dynamically allocating at least one communication cell to a cluster of communication cells based on the identified geographical location of the cell.

According to a third aspect of the invention, there is provided a base station for wirelessly communicating with remote communication units operational within a communication cell. The base station comprises location determination logic operable to determine a geographical location of the base station; message generation logic operable to generate a message that includes the identified geographical location of the base station at power up of the base station, and transmission logic operable to transmit the message to a network element, such that the base station is dynamically allocated to a cluster of communication cells based on the determined geographical location of the base station.

According to a fourth aspect of the invention, there is provided a method for allocating at least one communication cell to a cluster of communication cells. The method comprises determining a geographical location of a base station; generating a message that includes the identified geographical location of the base station at power up of the base station, and transmitting the message to a network element, wherein the network element is operable to dynamically allocate the base station to a cluster of communication cells based on the determined geographical location of the base station.

According to a fifth aspect of the invention, there is provided a semiconductor device comprising receive logic operable to receive a message that includes an identified geographical location of a base station, and allocation logic operable to dynamically allocate at least one communication cell to a cluster of communication cells based on the identified geographical location of the base station.

According to a sixth aspect of the invention, there is provided a semiconductor device comprising location determination logic operable to determine a geographical location of a base station in a wireless communication system; message generation logic operable to generate a message that includes the identified geographical location of the base station at power up of the base station, and transmission logic operable to transmit the message to a network element, such that the base station is dynamically allocated to a cluster of communication cells based on the determined geographical location of the base station.

According to a seventh aspect of the invention, there is provided a communication system. The communication system comprises a network element and a base station for communicating therebetween, wherein the base station comprises location identification logic operable to identify a geographical location of the base station and transmission logic operable to transmit the identified geographical location of the base station to the network element. The network element comprises allocation logic operable to dynamically allocate at least one communication cell to a cluster of communication cells based on an identified geographical location of the base station supporting communications in the at least one communication cell.

According to an eighth aspect of the invention, there is provided a computer readable medium comprising executable program code for allocating at least one communication cell to a cluster of communication cells. The computer readable medium comprises executable program code for identifying a geographical location of the at least one communication cell; and dynamically allocating the at least one communication cell to a cluster of communication cells based on the identified geographical location of the cell.

According to a ninth aspect of the invention, there is provided there is provided a computer readable medium comprising executable program code for allocating at least one communication cell to a cluster of communication cells. The computer program product comprises program code for determining a geographical location of a base station; generating a message that includes the identified geographical location of the base station at power up of the base station, and transmitting the message to a network element, such that the base station is dynamically allocated to a cluster of communication cells based on the determined geographical location of the base station by the network element.

These and other aspects, features and advantages of the invention will be apparent from, and elucidated with reference to, the embodiments described hereinafter.

### BRIEF DESCRIPTION OF THE DRAWINGS

Embodiments of the invention will now be described, by way of example only, with reference to the accompanying drawing(s), in which:

FIG. 1 illustrates an example of a known architecture for providing multimedia broadcast multicast services (MBMS).

FIG. 2 illustrates an example of a system adapted to control cluster layouts in an MBSFN network according to embodiments of the invention.

FIG. 3 illustrates a cell-based communication system for providing broadcast and/or multicast content according to embodiments of the invention.

FIG. 4 illustrates the routing of cluster information in the communication system of FIG. 2 according to embodiments of the invention.

FIG. 5 illustrates an exemplary flowchart of an operation of a network element, such as a radio resource management logic module, according to embodiments of the invention.

FIG. 6 illustrates an exemplary flowchart of an operation of a base station according to embodiments of the invention.

FIG. 7 illustrates a typical computing system that may be employed to implement processing functionality in embodiments of the invention.

### DESCRIPTION OF EMBODIMENTS OF THE INVENTION

In Multicast/Broadcast over a Single Frequency Network (MBSFN), Broadcast services are transmitted simultaneously using identical physical resources, by either all cells in the network or by clusters of cells in close proximity to each other. In an MBSFN system, cells involved in the broadcast of a service will effectively be transmitting the same signal/waveform allowing for efficient combination of the received signal from multiple cells.

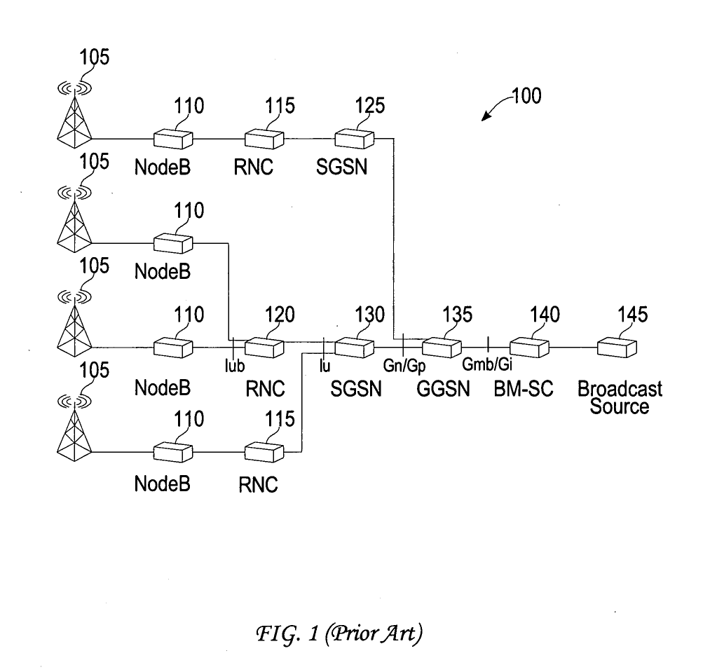

FIG. 1 illustrates a simplified example of a known architecture 100 for providing MBMS on a shared network basis. The architecture 100 comprises an operator network, such as, by way of example, a General Packet Radio System (GPRS), a Universal Mobile telecommunication System (UMTS), or an evolved Packet System (EPS) network. The operator network comprises a communication node 110, such as a base station (referred to as a NodeB in 3GPP parlance), which is wirelessly coupled to one or more user equipment (UE) devices (not shown), such as, by way of example, a mobile telephone handset, via a wireless interface and a number of antenna sites 105. The operator network further comprises a number of Radio Network Controllers (RNCs) 115, 120. As illustrated, a single RNC 115 can be operably coupled to a single Node B 110, or a single RNC 120 can be operably coupled to multiple Node Bs 110. RNCs 115, 120 configure the physical resources of the individual Node Bs 110 for the multimedia services and provide the data to the Node Bs 110 ready for transmission.

Additionally, each RNC 115, 120 is operably coupled to a service gateway support node (SGSN) 125, 130. As illustrated, a single SGSN 125 can be operably coupled to a single RNC 115, or a single SGSN 130 can be operably coupled to multiple RNCs 115, 120. The SGSNs 125, 130 allocate the necessary resources within the RNCs 115, 120 that are responsible for individual cells (NodeBs 110). The SGSNs 125, 130 forward the multimedia data streams for the services to the RNCs 115, 120.

A Gateway GPRS Support Node (GGSN) 135 may be operably coupled to multiple SGSNs 125, 130, as illustrated. The GGSN 135 may be operably coupled to a Broadcast Multicast Service Centre (BM-SC) 140, which in turn may be operably coupled to any network, for example a shared MBMS network comprising at least one source of broadcast media 145. The GGSN 135 identifies the necessary paths for data to be routed to subscribing mobile stations (UEs), as well as reserving the necessary resources through the SGSNs 125, 130. The GGSN 135 also provides the SGSNs 125, 130 with the multimedia data for the requested service(s) as received from the BM-SC 140. The BM-SC 140 handles the announced services and allocates resources in the MBMS network through the GGSN 135. Multimedia data for the services provided is forwarded to the GGSN 135 as packetized data, for example using Internet Protocol (IP) multicast techniques.

In this manner, services are announced by, and data for services are provided by, the broadcast media source 145 (sometimes referred to as a content provider). The MBMS network may be utilised for the provision of, for example, Mobile TV by more than one operator to the UEs by way of broadcasting/multicasting content streams.

Mobile TV is an example of a service that may be provided over MBMS. Mobile TV is a service provided to subscribers via mobile telecommunications networks, thereby providing television services to mobile devices. From the perspective of a mobile terminal, such as a 3rd generation user equipment (UE), receiving broadcast signals transmitted from multiple cells is identical to receiving signals transmitted from a single cell with different propagation delays. One of the challenges when managing such a network is the assignment of communication cells to cell clusters.

The following embodiments of the invention will be described in the context of a Multimedia Broadcast Multicast Service (MBMS), as defined in 3GPP TS 22.146, 3GPP TS 23.246 and 3GPP TS 26.346. However, it will be appreciated by a skilled artisan that the inventive concept described herein may be applied to alternative comparable multimedia services.

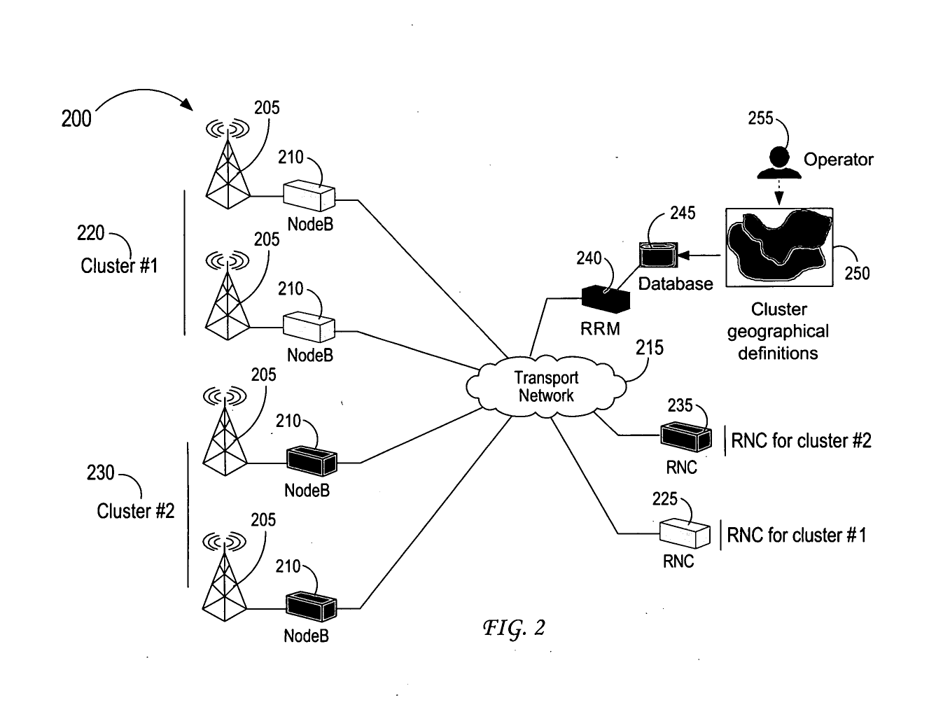

Referring now to FIG. 2, an exemplary system configuration 200, adapted according to embodiments of the invention, is illustrated. The exemplary system configuration 200 is described with respect to a UMTS Terrestrial Radio Access (UTRA) system. An operator network comprises a plurality of communication nodes 210, such as a base station (referred to as a NodeB in 3GPP parlance), which are wirelessly coupled to one or more user equipment (UE) devices (not shown), such as, by way of example, a mobile telephone handset, via a wireless interface and a number of associated antenna sites 205. The Node Bs are operably coupled to the remaining parts of the system architecture by a transport network 215. Thus, the NodeBs 210 are operably coupled to, and their operation controlled by, radio network controllers (RNCs) 225, 235 and other higher layer network elements (not shown). The transport network 215 also facilitates radio resource management (RRM) control via RRM logic module 240.

The example schematic shown in FIG. 2 illustrates a network layout based on UTRA-TDD. Four cells (NodeBs 210) are controlled by first RNC 225 and second RNC 235. An RRM logic module 240 is arranged to assign the cells (NodeBs 210) to the RNCs 225, 235 as the NodeBs 210 report their presence to the network.

In accordance with an embodiment of the invention, the cellular network is used to deliver only broadcast services, operating as an MBSFN. Here, each individual communication cell is configured as a part of a cluster of cells, for example cluster#1 220 and cluster#2 230. A cluster of communication cells either defines a subset of the cells of the network or all of the cells of the network. In an alternative embodiment of the invention the cellular network may be used to deliver broadcast services, for example operating as an MBSFN, concurrently (e.g. in parallel) with normal, duplex cellular communications.

Broadcast services are transmitted simultaneously using identical physical resources by all cells of a cluster 220, 230, thereby allowing UEs to combine signals received from more than one communication cell. Broadcast services may be transmitted by more than one cluster 220, 230, in which case all cells within a particular cluster will use identical physical resources for the broadcast.

Each cell (effectively the NodeB 210 supporting communication in the cell) is able to produce data that specifies its exact geographical location, either through the use of a geographical positioning system (GPS) receiver or through other known means. At present, all UMTS cells use GPS to support time synchronisation between cells. In an alternative embodiment of the invention, for example, each NodeB may be hard-coded with the data that specifies its exact geographical location. Thus, each cell will, when powered on, indicate its presence in the network infrastructure by generating an initial control plane message in a message generation logic module and sending the initial control plane message to a Radio Resource Management (RRM) logic module 240 and then wait for cell configuration data to be returned from a Radio Network Controller (RNC) 220, 230. Notably, the message from the NodeB 210 includes its geographical position information in the initial message.

In accordance with embodiments of the invention, the RRM logic module 240 is coupled to a memory 245 that receives an input of a cluster of geographical definitions 250. Cells are assigned to cell clusters as a part of the provisioning process for the network. In accordance with embodiments of the invention, the allocation of cells is performed by an allocation logic module such that the memory 245 contains information identifying the geographical layout of the clusters 220, 230 that are to make up the network structure, as specified by the Network Operator 255 that is managing the network. Thus, the geographical layout of a cluster 220, 230 defines a geographical area. All cells with a geographical location falling within the geographical area that is defined for a particular cluster 220, 230 are configured to belong to that cluster 220, 230.

Furthermore, in accordance with embodiments of the invention, the RRM logic module 240 is arranged to access the memory 245 in order to determine the geographical layouts of clusters 220, 230 defined by the Network Operator 255 that is managing the network.

In operation, whenever a cell is powered on, the NodeB 210 indicates its presence to the RRM logic module 240 of the network, and includes information about its geographical location. The RRM logic module 240 implements an algorithm that is able to determine the cluster association of the cell based on the geographical location of the cell and the information about geographical layouts of clusters available from the memory.

The RRM logic module 240 is arranged to assign/allocate the cell to an RNC 225, 235 that is responsible for the control of cells for the relevant cluster in that geographical location, according to the outcome of the algorithm. The first RNC 225 or second RNC 235, to which the cell is allocated, then takes control of the cell and configures it as part of the relevant cluster of cells.

Thus, NodeBs are assigned to a cluster based on their physical geographical location. New cells (and hence associated NodeBs) that are added to the network do not need to be explicitly assigned to a cluster, since their geographical location will determine to which cluster they belong. Changing the content of the memory, for example by re-defining the geographical area of one or more clusters, causes the RRM logic module 240 to reassign the first RNC 225 or second RNC 235 that is responsible for the affected cells, thereby maintaining the correct cluster layout.

In this example, the RRM logic module 240 and the memory 245 are shown as separate network elements. However, in alternative examples, these two entities may be co-located in a single entity or form part of another element, which may combine the functionality of the first RNC 225 or second RNC 235, RRM logic module 240 and memory 245 for the dedicated broadcast network.

In one example, the definition of the geographical areas may be performed through an application running on a device that is located external to the RRM logic module 240 and memory 245. In this embodiment, this application may provide the Network Operator 255 with the means to define the area to be covered by a cluster through, for example, a graphical user interface, e.g., using a digital or conventional map, or through other known means. For example, the digital or conventional map may be based on radio coverage topological data, etc. as well as location data.

In accordance with an alternative embodiment of the invention, the RRM logic module 240 of the network is configured in order to enable an application running on an external device to graphically illustrate the cells of the network to the Network Operator that is managing the network. Here, the RRM logic module 240 may provide an interface for accessing the location information for all cells that are a part of the network.

The location information may also include information about the cluster to which the cells have been assigned. An application running on an external device will access the information from the RRM logic module 240 and provide the Network Operator that is managing the network with a graphical representation of the network. Here, the graphical representation may include:

(i) The geographical position of each cell.

(ii) An estimate of the actual geographical coverage of each cluster, as compared to the cluster area definitions provided to the RRM logic module 240 through the memory 245 by the Network Operator 255.

(iii) Highlighted alerts for areas with a high probability of interference based on estimates of cell overlaps in cell border areas between clusters.

(iv) Highlighted alerts for areas with an estimated high probability of poor coverage for mobile stations trying to receive signals from the communication cells of a cell cluster.

For example, with respect to the highlighted alerts aspect, the application may compare the actual position of cells to the cluster geographical definitions. Furthermore, the application may determine whether or not there is a good probability that the cells that actually exist in the system will achieve the layout defined geographically by the Network Operator 255, for example both in terms of actual coverage and interference.

In one example, the application may allow the Network Operator to modify the layout of a cluster geographical area through an interface, thereby allowing the Network Operator to select a specific cell (or a set of cells) and include them in a cluster. In this manner, the Network Operator is able to modify the geographical layout of the cluster and trigger an update of the cluster definition in the memory 245 used by the RRM logic module 240.

In an alternative embodiment of the invention, the cells may be configured to report a direction and beamwidth of their respective antenna array(s). In this way, Network Operators may perform automatic cluster layout designs based on combined power and coverage data, and thereby have the ability to adjust the power on each antenna separately and observe the estimated consequence for coverage on a map directly.

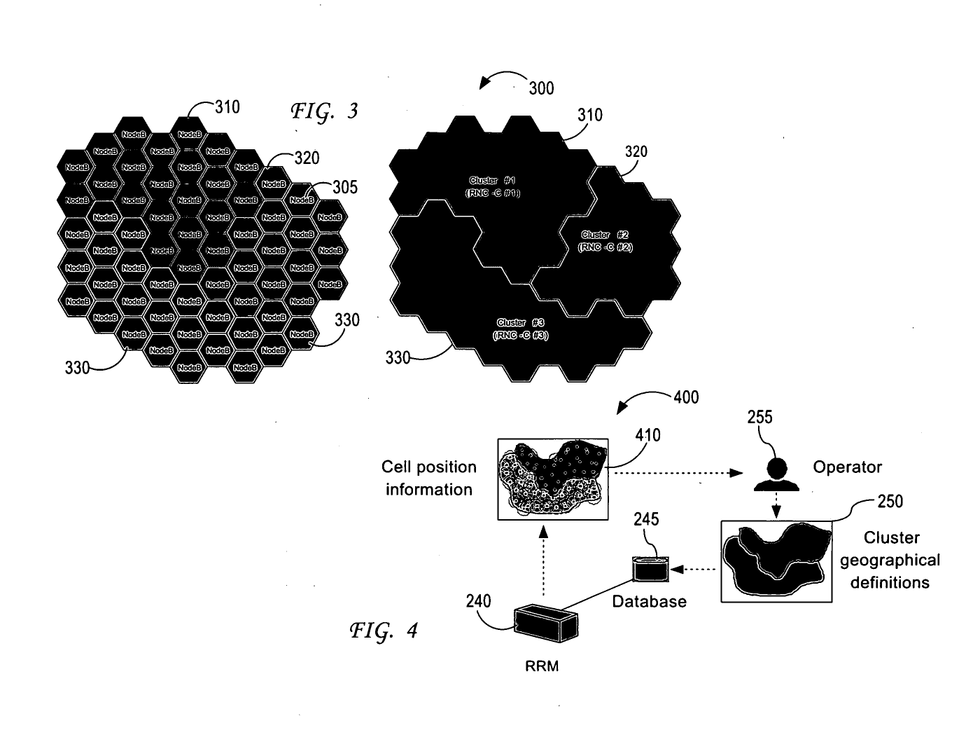

Referring now to FIG. 3, there is illustrated an exemplary communication system 300 for supporting broadcast and/or multicast content according to embodiments of the invention. For example, the exemplary communication system 300 may be a time division code division multiple access (TD-CDMA) based cellular system, such as an Universal Mobile Telecommunication System (UMTS) Terrestrial Radio Access time division duplex (UTRA-TDD) system. The exemplary communication system 300 comprises a multitude of communication cells with communications supported therein by respective Node Bs 305. In accordance with one embodiment of the invention, multiple cells with respective Node Bs are grouped together in a number of clusters 310, 320, 330, according to their geographical locations, as identified by the respective NodeBs. In the example shown in FIG. 3, three clusters are defined to which services can be mapped by radio resource management (RRM) logic module.

Referring now to FIG. 4, an exemplary illustration 400 of how cell clusters are defined according to embodiments of the invention is illustrated. RRM logic module 240 provides real-time cell position information 410 to a Network Operator 255. The Network Operator 255 (or some logical entity within the network) provides an input of a cluster of geographical definitions 250 based on this cell position information 410. The cell cluster definitions may be stored in memory 245, which is operably coupled to the RRM logic module 240 via a suitable interface.

In this manner, the management of the MBSFN cluster definitions may be performed using a definition of geographical areas. Thus, any cell placed within the geographical area defined for a cluster will automatically be allocated to the correct cluster by the RRM logic module 240. This makes it possible to deploy new cells in the network with very little effort with regard to configuration. For example, this concept may be particularly applicable to a mixed macro-cell/femto-cell system. Here, many femto-cells, e.g., in in-building environments, will dynamically appear/disappear within a coverage area of a plurality of macro-cells. Since cells in many cellular networks already have access to GPS, used to enable synchronisation of Node B transmissions, the cost associated with obtaining the necessary location information from NodeBs is low.

Dynamic reconfiguration of the network, in the context of reconfiguration of cells allocated to a cluster, is made possible through an update of the network layout mapping information stored in the memory 245. RRM logic module 240 reacts to this update and reconfigures the cells and RNCs to reflect the updated layout.

Thus, embodiments of the invention facilitate the representation of the cell clusters of the network based on a geographical representation of the network, rather than on a list of communication cells. This is in contrast to an implementation of an MBSFN wherein the representation of a cell cluster would be in a form of a list of communication cells without association to a geographical area. In this manner, embodiments of the invention provide an advantage to the Network Operator by being able to associate broadcast services that are to be transmitted with a geographical area rather than a list of cells.

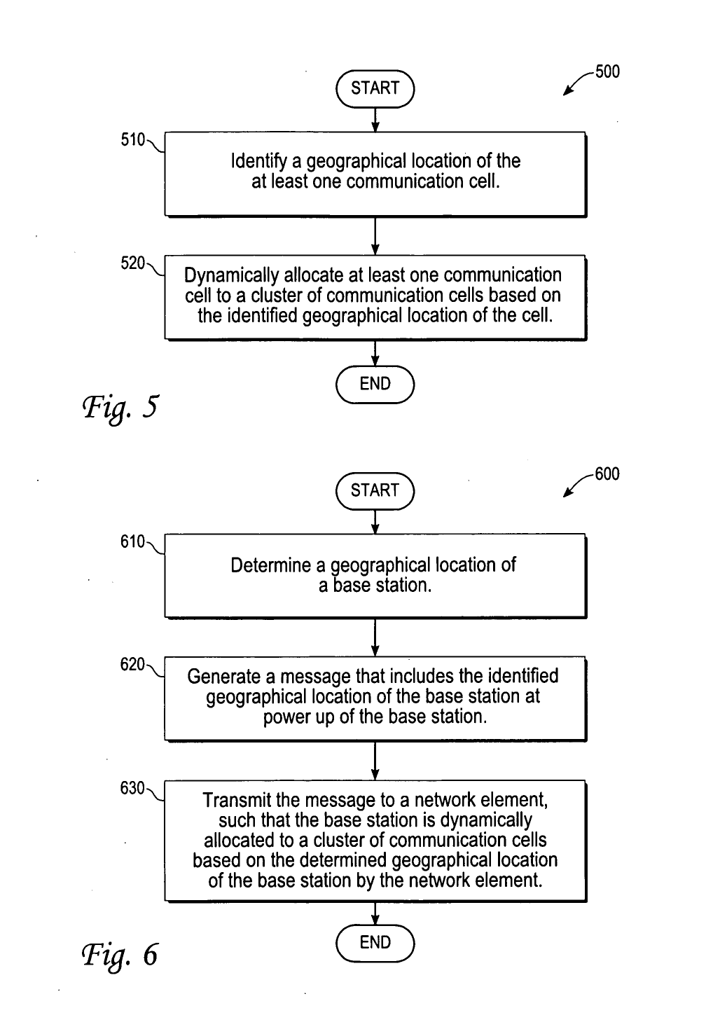

Referring now to FIG. 5, an exemplary flowchart 500 of an operation of a network element, such as a radio resource management logic module, according to embodiments of the invention, is illustrated. The exemplary flowchart 500 for allocating at least one communication cell to a cluster of communication cells comprises identifying a geographical location of the at least one communication cell, as shown in step 510. The flowchart 500 further comprises dynamically allocating at least one communication cell to a cluster of communication cells based on the identified geographical location of the cell, as shown in step 520.

Referring now to FIG. 6, an exemplary flowchart 600 of an operation of a base station, according to embodiments of the invention, is illustrated. The exemplary flowchart 600 for allocating at least one communication cell to a cluster of communication cells comprises determining a geographical location of the base station, as shown in step 610 and generating a message that includes the identified geographical location of the base station at power up of the base station, as shown in step 620. In an optional embodiment of the invention, the message may also include additional information, such as antenna array data, for example antenna direction, antenna beamwidth, and the like. The exemplary flowchart 600 further comprises transmitting the message to a network element, such that the base station is dynamically allocated to a cluster of communication cells based on the determined geographical location of the base station by the network element, as shown in step 630.

As will be appreciated by a skilled artisan, only those logical/functional components necessary for describing the inventive concept are illustrated herein, and accordingly RRM logic, etc. may comprise further logical/functional components (not shown).

While the invention has been described in terms of particular embodiments and illustrative figures, those of ordinary skill in the art will recognize that the invention is not limited to the embodiments or figures described. Although embodiments of the invention are described, in some instances, with respect to the defining of cell clusters in a UTRA-TDD based MBMS network, for example operating in dedicated broadcast mode as an MBSFN, the embodiments may be applied to any other cellular network operating as an MBSFN (or in an MBSFN like manner), where communication cells are sending the same or similar information content.

Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term ‘logic’ herein refers to fixed hardware, programmable logic and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

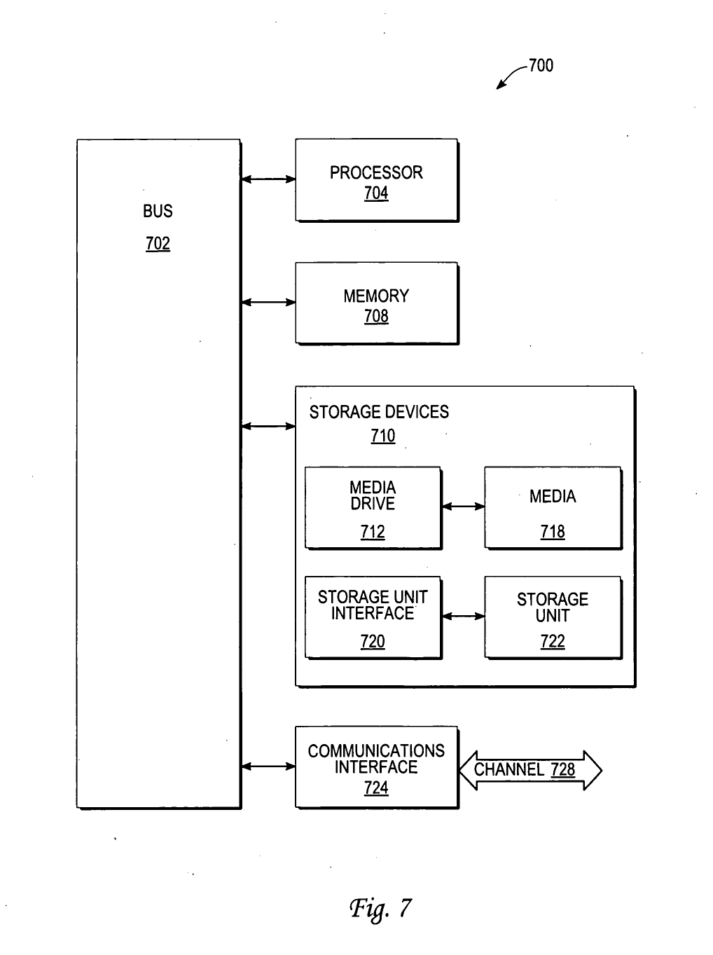

FIG. 7 illustrates a typical computing system 700 that may be employed to implement processing functionality in embodiments of the invention. Computing systems of this type may be used in the Broadcast Integrated Network Controller (in particular, the RRM logic, for example. Those skilled in the relevant art will also recognize how to implement the invention using other computer systems or architectures. Computing system 700 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 700 can include one or more processors, such as a processor 704. Processor 704 can be implemented using a general or special purpose processing engine such as, for example, a microprocessor, microcontroller or other control logic. In this example, processor 704 is connected to a bus 702 or other communication medium.

Computing system 700 can also include a main memory 708, such as random access memory (RAM) or other dynamic memory, for storing information and instructions to be executed by processor 704. Main memory 708 also may be used for storing temporary variables or other intermediate information during execution of instructions to be executed by processor 704. Computing system 700 may likewise include a read only memory (ROM) or other static storage device coupled to bus 702 for storing static information and instructions for processor 704.

The computing system 700 may also include information storage system 710, which may include, for example, a media drive 712 and a removable storage interface 720. The media drive 712 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 718 may include, for example, a hard disk, floppy disk, magnetic tape, optical disk, CD or DVD, or other fixed or removable medium that is read by and written to by media drive 712. As these examples illustrate, the storage media 718 may include a computer-readable storage medium having stored therein particular computer software or data.

In alternative embodiments, information storage system 710 may include other similar components for allowing computer programs or other instructions or data to be loaded into computing system 700. Such components may include, for example, a removable storage unit 722 and an interface 720, such as a program cartridge and cartridge interface, a removable memory (for example, a flash memory or other removable memory module) and memory slot, and other removable storage units 722 and interfaces 720 that allow software and data to be transferred from the removable storage unit 718 to computing system 700.

Computing system 700 can also include a communications interface 724. Communications interface 724 can be used to allow software and data to be transferred between computing system 700 and external devices. Examples of communications interface 724 can include a modem, a network interface (such as an Ethernet or other NIC card), a communications port (such as for example, a universal serial bus (USB) port), a PCMCIA slot and card, etc. Software and data transferred via communications interface 724 are in the form of signals which can be electronic, electromagnetic, optical or other signals capable of being received by communications interface 724. These signals are provided to communications interface 724 via a channel 728. This channel 728 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’ ‘computer-readable medium’ and the like may be used generally to refer to media such as, for example, memory 708, storage device 718, or storage unit 722. These and other forms of computer-readable media may store one or more instructions for use by processor 704, to cause the processor to perform specified operations. Such instructions, generally referred to as ‘computer program code’ (which may be grouped in the form of computer programs or other groupings), when executed, enable the computing system 700 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 700 using, for example, a removable storage drive, drive 712 or communications interface 724. The control logic (in this example, software instructions or computer program code), when executed by the processor 704, causes the processor 704 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Although the invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

We claim:

1. A network element for supporting broadcast communications over a communication system, the network element comprising:
allocation logic operable to dynamically allocate at least one communication cell to a cluster of communication cells based on an identified geographical location of the at least one communication cell.

2. The network element of claim 1 further comprising:
processing logic operably coupled to the allocation logic, wherein the processing logic is operable to receive a message from the at least one communication cell upon power on of the at least one communication cell informing the network element of its geographical location, and
the allocation logic is operable to allocate the at least one communication cell to a cluster of communication cells based on the informed geographical location.

3. The network element of claim 1 further comprising:
memory logic operable to store geographical location information associated with a cluster of communication cells,
wherein the allocation logic is operable to allocate the at least one communication cell to a cluster of communication cells based on an identified geographical location of the cell obtained from the memory logic.

4. The network element of claim 1 further comprising:
extraction logic operable to extract geographical location information associated with a cluster of communication cells from a remote memory,
wherein the allocation logic is operable to allocate the at least one communication cell to a cluster of communication cells based on an identified geographical location of the cell obtained by the extraction logic.

5. The network element of claim 1, further comprising:
radio allocation logic operable to allocate the at least one communication cell to a radio network controller responsible for control of communication cells of the cluster.

6. The network element of claim 2 wherein the processing logic is further operable to receive an indication of an antenna performance of the at least one communication cell.

7. The network element of claim 6 wherein the antenna performance comprises at least one from a group of:
an antenna direction, and
antenna beamwidth.

8. The network element of claim 1 further comprising:
graphical user interface logic operable to provide a visual representation of a cluster of cells.

9. The network element of claim 1, further comprising:
additional processing logic operable to use the identified geographical location of the at least one communication cell to determine whether an area in the cluster has a relatively high probability of suffering from poor communication coverage.

10. The network element of claim 1 wherein the network element is operable to support broadcast data, and the broadcast data comprises Multicast Broadcast over a Single Frequency Network (MBSFN) data.

11. A computer-implemented method for allocating at least one communication cell to a cluster of communication cells, the method comprising:
identifying a geographical location of at least one communication cell; and
dynamically allocating the at least one communication cell to a cluster of communication cells based on the identified geographical location of the cell.

12. A base station for wirelessly communicating with remote communication units operational within a communication cell, the base station comprising:
location determination logic operable to determine a geographical location of the base station;
message generation logic operable to generate a message that includes the identified geographical location of the base station at power up of the base station; and
transmission logic operable to transmit the message to a network element, wherein the base station is dynamically allocated to a cluster of communication cells based on the determined geographical location of the base station.

13. A computer-implemented method for allocating at least one communication cell to a cluster of communication cells, the method comprising:
determining a geographical location of a base station;
generating a message that includes the identified geographical location of the base station at power up of the base station; and
transmitting the message to a network element, wherein the network element is operable to dynamically allocate the base station to a cluster of communication cells based on the determined geographical location of the base station.

14. A semiconductor device comprising:
receive logic operable to receive a message that includes an identified geographical location of a base station; and
allocation logic operable to dynamically allocate at least one communication cell to a cluster of communication cells based on the identified geographical location of the base station.

15. A semiconductor device comprising:
location determination logic operable to determine a geographical location of a base station in a wireless communication system;
message generation logic operable to generate a message that includes the identified geographical location of the base station at power up of the base station; and
transmission logic operable to transmit the message to a network element, wherein the base station is dynamically allocated to a cluster of communication cells based on the determined geographical location of the base station.

16. A communication system comprising a network element and a base station for communicating therebetween wherein the base station supports communications in at least one communication cell and comprises:
location identification logic operable to identify a geographical location of the base station; and
transmission logic operable to transmit the identified geographical location of the base station to the network element,
wherein the network element comprises:
allocation logic operable to dynamically allocate at least one communication cell to a cluster of communication cells based on the identified geographical location of the base station.

17. A computer readable medium comprising executable program code for:
identifying a geographical location of at least one communication cell; and
dynamically allocating the at least one communication cell to a cluster of communication cells based on the identified geographical location of the cell.

18. The computer-readable medium of claim 17, wherein the computer readable medium comprises at least one of a hard disk, CD-ROM, an optical storage device, a magnetic storage device, a Read Only Memory (ROM), a Programmable Read Only Memory (PROM), an Erasable Programmable Read Only Memory (EPROM), an Electrically Erasable Programmable Read Only Memory (EEPROM), and a Flash memory.

19. A computer readable medium comprising executable program code for:
determining a geographical location of a base station;
generating a message that includes the identified geographical location of the base station at power up of the base station; and
transmitting the message to a network element, wherein the network element is operable to dynamically allocate the base station to a cluster of communication cells based on the determined geographical location of the base station.

20. The computer readable medium of claim 19, wherein the computer readable medium comprises at least one of a hard disk, a CD-ROM, an optical storage device, a magnetic storage device, a Read Only Memory (ROM), a Programmable Read Only Memory (PROM), an Erasable Programmable Read Only Memory (EPROM), an Electrically Erasable Programmable Read Only Memory (EEPROM), and a Flash memory.
